(19) United States
(12) Patent Application Publication
(10) Pub. No.: US 2014/0036051 A1
(43) Pub. Date: Feb. 6, 2014

(54) MEDICINE SYSTEM

(71) Applicant: OLYMPUS MEDICAL SYSTEMS CORP., Tokyo (JP)

(72) Inventors: Saeri SAITO, Sagamihara-shi (JP); Jun KONISHI, Tokyo (JP); Hiroyuki USAMI, Tokyo (JP); Shigeru HOSOKAI, Tokyo (JP)

(21) Appl. No.: 13/966,640

(22) Filed: Aug. 14, 2013

Related U.S. Application Data
(63) Continuation of application No. PCT/JP2012/083357, filed on Dec. 21, 2012.

(30) Foreign Application Priority Data
Mar. 1, 2012 (JP) 2012-045446

(51) Int. Cl. H04N 5/217

(52) U.S. Cl. CPC H04N 5/217
USPC 348/68; 348/65

(57) ABSTRACT

A medical system includes an image pickup device configured to output, as image information, an electric signal after photoelectric conversion from a plurality of pixels, and a processing device that is connected to the image pickup device to allow bi-directional communication. The image pickup device includes a signal processing unit configured to perform a process of converting the electric signal into the image information, and to generate heat accompanying the process, a temperature detector that is provided in vicinity to the signal processing unit, and is configured to detect temperature of the signal processing unit, and an output unit configured to output temperature information on the temperature detected by the temperature detector, together with the image information. The processing device includes a controller configured to control the image pickup device based on the temperature information input from the output unit.

### CROSS-REFERENCE TO RELATED APPLICATIONS

This application is a continuation of International Application No. PCT/JP2012/083357, filed on Dec. 21, 2012 which claims the benefit of priority of the prior Japanese Patent Application No. 2012-045446, filed on Mar. 1, 2012, the entire contents of which are incorporated herein by reference.

### BACKGROUND OF THE INVENTION

1. Field of the Invention

The present invention relates to a medical system capable of outputting an electric signal after photoelectric conversion from an arbitrarily designated pixel that is a reading target of a plurality of imaging pixels, as image information.

2. Description of the Related Art

In the conventional medical field, an endoscope system is used when observing an organ of a subject such as a patient. The endoscope system includes an imaging device (an electronic scope) that has an elongated shape and flexibility, for example and is configured to be inserted into a body cavity of a subject, an image pickup device that is provided at a distal end of the imaging device and captures an in-vivo image, a processing device (an external processor) that performs a specified image process on the in-vivo image captured by the image pickup device, and a display device that can display the in-vivo image subjected to the image process by the processing device. When the in-vivo image is acquired using the endoscope system, an insertion unit is inserted into the body cavity of the subject, then a living tissue in the body cavity is irradiated with illumination light from the distal end of the insertion unit, and the image pickup device captures an in-vivo image. A user such a doctor observes the organ of the subject based on the in-vivo image displayed by the display device.

As such an endoscope system, a technique of preventing deterioration of image quality with temperature rising of the image pickup device by detecting a temperature of the image pickup device is known (see Japanese Laid-open Patent Publication No. 2003-079569). In this technique, a temperature sensor is provided in the vicinity of the image pickup device, the deterioration of the image quality is prevented by correcting an image signal output from the image pickup device based on the temperature detected by the temperature sensor.

### SUMMARY OF THE INVENTION

A medical system according to one aspect of the invention includes: an image pickup device configured to output, as image information, an electric signal after photoelectric conversion from a plurality of pixels; and a processing device that is connected to the image pickup device to allow bi-directional communication. The image pickup device includes: a signal processing unit configured to perform a process of converting the electric signal into the image information, and to generate heat accompanying the process, a temperature detector that is provided in vicinity to the signal processing unit, and is configured to detect temperature of the signal processing unit, and an output unit configured to output temperature information on the temperature detected by the temperature detector, together with the image information. The processing device includes a controller configured to control the image pickup device based on the temperature information input from the output unit.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic configuration of an endoscope system according to a first embodiment of the invention;

FIG. 2 is block diagram illustrating a functional configuration of main parts of the endoscope system according to the first embodiment of the invention;

FIG. 3 is a schematic view illustrating a configuration of an image pickup device of an endoscope in the endoscope system according to the first embodiment of the invention;

FIG. 4 is a flowchart illustrating an outline of a process performed by the endoscope system according to the first embodiment of the invention;

FIG. 5 is a schematic view illustrating a configuration of an image pickup device of an endoscope in an endoscope system according to a second embodiment of the invention; and

FIG. 6 is an enlarged view schematically enlarging some main parts of a normal pixel including a temperature detecting circuit according to the second embodiment of the invention.

### DETAILED DESCRIPTION OF THE PREFERRED EMBODIMENTS

Hereinafter, as an embodiment for embodying the invention, a medical endoscope system that captures and displays an image in a body cavity of a subject such as a patient will be described as a medical system. In addition, the invention is not limited by the embodiment. In addition, in description of the drawings, the same reference signs are given to the same portions. In addition, the drawings are schematic, it is necessary to note that a relation between a thickness and a width of each member, and a ratio of each member are different from reality. In addition, a portion with dimensions and ratios different from each other even in the drawings is included.

### First Embodiment

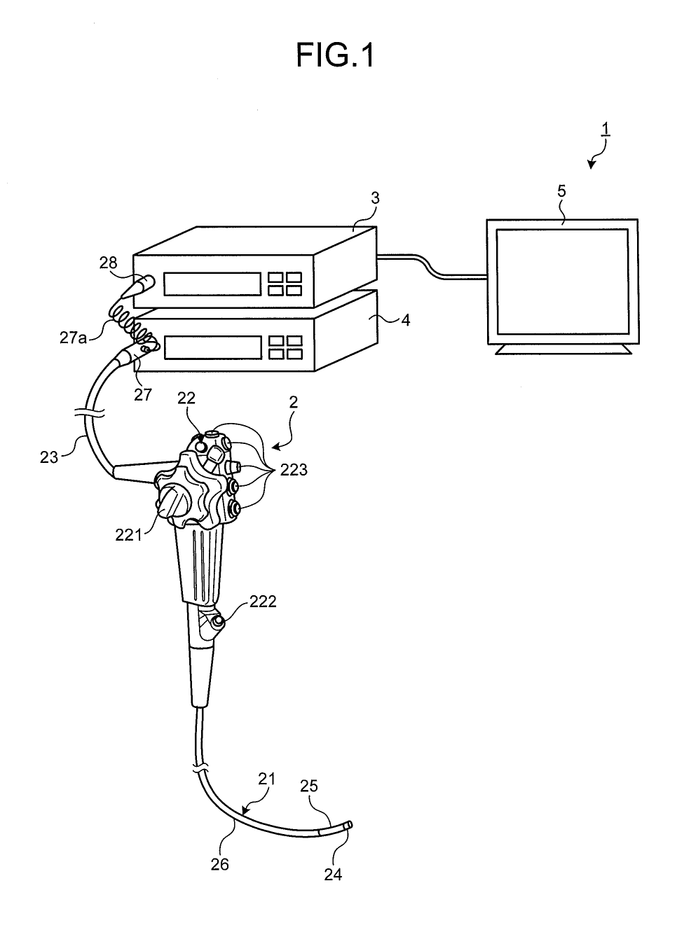

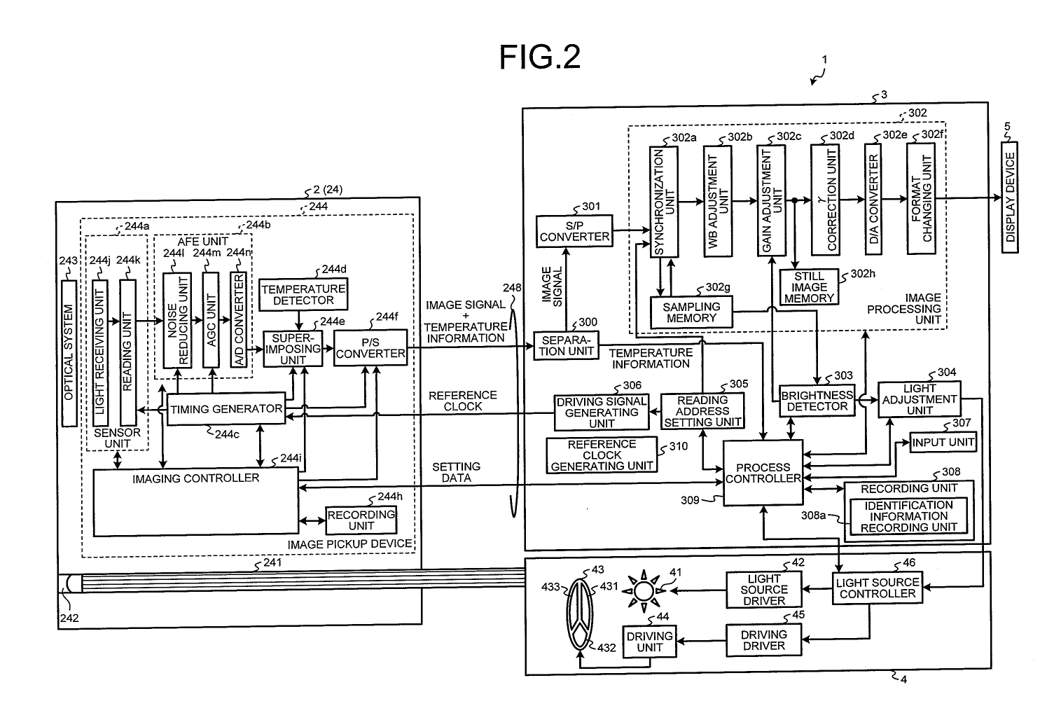

FIG. 1 is a diagram illustrating a schematic configuration of an endoscope system according to a first embodiment of the invention. FIG. 2 is a block diagram illustrating a functional configuration of main parts of the endoscope system according to the first embodiment of the invention.

As illustrated in FIGS. 1 and 2, an endoscope system 1 includes an endoscope 2 (an electronic scope) as an imaging device that captures an in-vivo image of a subject by inserting a distal end portion into a body cavity of the subject, a processing device 3 (an external processor) that performs a specified image process on the in-vivo image captured by the endoscope 2, and generally controls an overall operation of the endoscope system 1, a light source device 4 that generates illumination light output from a distal end of the endoscope 2, and a display device 5 that displays the in-vivo image subjected to the image process by the processing device 3.

The endoscope 2 includes an insertion unit 21 that has an elongated shape with flexibility, an operating unit 22 that is connected to a proximal end side of the insertion unit 21 and receives an input of various operation signals, and a universal cord 23 that extends in a direction different from an extending direction of the insertion unit 21 from the operating unit 22, and is provided therein with various cables connecting the processing device 3 and the light source device 4.

The insertion unit 21 includes a distal end portion 24 provided therein with an image pickup device to be described later, a bendable curved portion 25 that is configured by a plurality of curved pieces, and an elongated flexible tube portion 26 that is connected to a proximal end side of the curved portion 25 and has flexibility.

The distal end portion 24 includes a light guide 241 that is configured using glass fiber and forms a light guide path of light emitted by the light source device 4, an illumination lens 242 that is provided at a distal end of the light guide 241, an optical system 243 for condensing, and an image pickup device 244 that is provided at an imaging portion of the optical system 243, receives the light condensed by the optical system 243, photoelectrically converts the light into an electric signal, and performs a specified signal process.

The optical system 243 is configured using one or a plurality of lenses, and has an optical zoom function of changing an angle of view and a focus function of changing a focus.

The image pickup device 244 includes a sensor unit 244a that photoelectrically converts the light from the optical system 243 and outputs an electric signal, an analog front end 244b (hereinafter, referred to as an “AFE unit 244b”) that performs noise removal and A/D conversion on the electric signal output from the sensor unit 244a, a timing generator 244c that generates a driving timing of the sensor unit 244a and pulses of various signal processes in the AFE unit 244b, a temperature detector 244d that detects a temperature in the image pickup device 244, a superimposing unit 244e that superimposes the digital signal (the image signal) output from the AFE unit 244b and the temperature information input from the temperature detector 244d and transmits the image signal to a P/S converter 244f, the P/S converter 244f that performs parallel/serial conversion on the image signal output from the superimposing unit 244e and transmits the image signal to the outside, a recording unit 244h that records various kinds of information of the image pickup device 244, and an imaging controller 244i that controls an operation of the image pickup device 244. The image pickup device 244 is a complementary metal oxide semiconductor (CMOS) image sensor.

The sensor unit 244a includes a light receiving unit 244j in which a plurality of pixels each having a photodiode accumulating charges corresponding to light quantity and an amplifier amplifying the charges accumulated by the photodiode are arranged in a two-dimensional matrix shape, and a reading unit 244k that reads, as image information, an electric signal generated by an pixel arbitrarily set as a reading target of the plurality of pixels of the light receiving unit 244j.

The AFE unit 244b includes a noise reducing unit 244l that reduces a noise component included in the electric signal (analog), an auto gain control (AGC) unit 244m that adjusts an amplification rate (gain) of the electric signal and maintains a certain output level, and an A/D converter 244n that performs A/D conversion on the electric signal as the image information (the image signal) output through the AGC unit 244m. The noise reducing unit 244l reduces noise using a correlated double sampling method, for example.

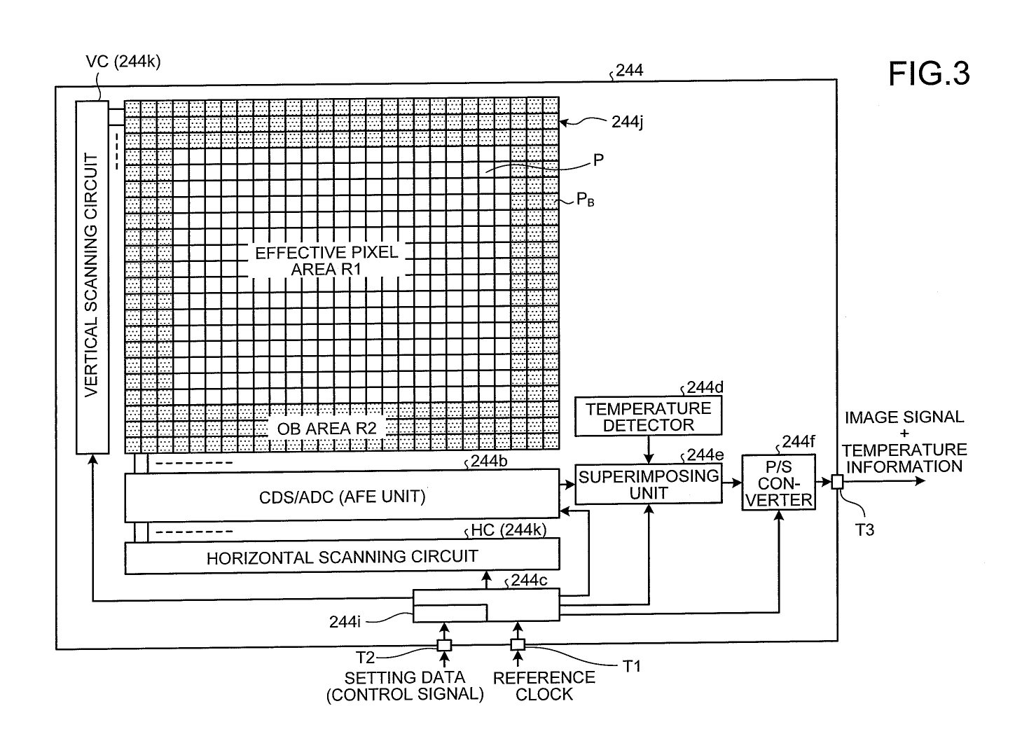

Here, a specific configuration of the image pickup device 244 will be described. FIG. 3 is a schematic view illustrating a configuration of the image pickup device 244.

As described above, the sensor unit 244a of the image pickup device 244 illustrated in FIG. 3 includes: the light receiving unit 244j that photoelectrically converts the light from the optical system 243 and outputs the electric signal as the image information and in which a plurality of pixels P each having the photodiode accumulating the charges corresponding to the light quantity and the amplifier amplifying the charges accumulated by the photodiode are arranged in the two-dimensional matrix shape; and a vertical scanning circuit VC (a line selection circuit) and a horizontal scanning circuit HC (a column selection circuit) as the reading unit 244k that reads, as image information, the electric signal generated by the pixel P arbitrarily set as the reading target of the plurality of pixels P of the light receiving unit 244j. The vertical scanning circuit VC and the horizontal scanning circuit HC are circuits connected to each of the pixels P to select the pixel. The horizontal scanning circuit HC outputs the electric signal from each of the pixels P to the outside. In addition, the light receiving unit 244j includes an effective pixel area R1 for outputting as pixel information, and an optical block area R2 (hereinafter, referred to as an “OB area R2”) that is constantly light-blocked by a film or the like to detect an output in the dark. The OB area R2 is used to detect whether or not a noise level exceeds a specified value by monitoring an output level of the pixel P_{B} output from the OB area R2 by the imaging controller 244i.

The timing generator 244c generates a driving timing of the image pickup device 244 based on a reference clock input from an input terminal T1.

The temperature detector 244d is disposed in the vicinity of the AFE unit 244b which generates a relatively high heat. Specifically, the temperature detector 244d is disposed in the vicinity of the A/D converter 244n of the AFE unit 244b. The temperature detector 244d monitors a forward voltage of PN junction, and quantizes it to detect the temperature of the image pickup device 244. The temperature detector 244d performs A/D conversion on temperature information about the detected temperature, and outputs the temperature information to the superimposing unit 244e.

The superimposing unit 244e outputs a superimposing signal obtained by superimposing the digital temperature information (the electric signal) input from the temperature detector 244d on the digital signal (the image signal) output from the AFE unit 244b, to the P/S converter 244f. In the first embodiment, the superimposing unit 244e serves as an output unit.

The P/S converter 244f performs parallel/serial conversion on the image signal output from the superimposing unit 244e, and transmits the image signal to the outside through an output terminal T3.

The imaging controller 244i controls various operations of the image pickup device 244 based on setting data (a control signal) input from the input terminal T2.

Returning to FIGS. 1 and 2, a configuration of the endoscope 2 will be subsequently described.

The operating unit 22 includes a curved knob 221 that vertically and horizontally curves the curved portion 25, a treatment tool insertion unit 222 that inserts a treatment tool such as a biological forceps, a laser scalpel, and an examination probe into the body cavity, and a plurality of switches 223 that are operation input units for inputting an operation instruction signal of a peripheral device such as an air supply unit, a water supply unit, and a gas supply unit, in addition to the processing device 3 and the light source device 4. The treatment tool inserted from the treatment tool insertion unit 222 gets out of an aperture portion (not illustrated) through a treatment tool channel (not illustrated) of the distal end portion 24.

The universal cord 23 is provided therein with at least a light guide 241 and a collective cable 248 including one or more cables. The universal cord 23 has a connector portion 27 detachably attached to the light source device 4. The connector portion 27 is provided with a coil-shaped extending coil cable 27a, and has a connector portion 28 detachably attached to the processing device 3 at the extending end of the coil cable 27a.

Next, a configuration of the processing device 3 will be described. The processing device 3 includes a separation unit 300, an S/P converter 301, an image processing unit 302, a brightness detector 303, a light adjustment unit 304, a reading address setting unit 305, a driving signal generating unit 306, an input unit 307, a recording unit 308, a process controller 309, and a reference clock generating unit 310.

The separation unit 300 separates the superimposing signal in which the temperature information is superimposed on the image signal input from the image pickup device 244 into the image signal and the temperature information, outputs the image signal to the S/P converter 301, and outputs the temperature information to the process controller 309.

The S/P converter 301 performs serial/parallel conversion on the image signal (the electric signal) input from the separation unit 300, and outputs the image signal to the image processing unit 302.

The image processing unit 302 generates an in-vivo image displayed by the display device 5 based on the image signal input from the S/P converter 301. The image processing unit 302 includes a synchronization unit 302a, a white balance (WB) adjustment unit 302b, a gain adjustment unit 302c, a γ correction unit 302d, a D/A converter 302e, a format changing unit 302f, a sampling memory 302g, and a still image memory 302h.

The synchronization unit 302a inputs the image information input as the pixel information to three memories (not illustrated) provided for each pixel, keeps the value of each memory while sequentially updating the value of each memory in association with the address of the pixel of the light receiving unit 244j read by the reading unit 244k, and synchronizes the image information of three memories as RGB image information. The synchronization unit 302a sequentially outputs the synchronized RGB image information to the white balance adjustment unit 302b, and outputs part of the RGB image information to the sampling memory 302g for image analysis such as brightness detection.

The white balance adjustment unit 302b automatically adjusts white balance of the RGB image information. Specifically, the white balance adjustment unit 302b automatically adjusts the white balance of the RGB image information based on a color temperature included in the RGB image information.

The gain adjustment unit 302c performs gain adjustment of the RGB image information. The gain adjustment unit 302c outputs the gain-adjusted RGB signal to the γ correction unit 302d, and outputs a part of the RGB signal to the still image memory 302h for still image display, enlarged image display, or emphasized image display.

The γ correction unit 302d performs tone correction (γ correction) of the RGB image information in association with the display device 5.

The D/A converter 302e converts the RGB image information after the tone correction output from the γ correction unit 302d into an analog signal.

The format changing unit 302f changes the image information converted into the analog signal to a moving image file format such as high-vision, and outputs the image information to the display device 5.

The brightness detector 303 detects a brightness level corresponding to each pixel from the RGB image information kept in the sampling memory 302g, records the detected brightness level in a memory provided therein, and outputs the detected brightness level to the process controller 309. In addition, the brightness detector 303 calculates a gain adjustment value and a light irradiation amount based on the detected brightness level, outputs the gain adjustment value to the gain adjustment unit 302c, and outputs the light irradiation amount to the light adjustment unit 304.

The light adjustment unit 304 sets a type, light quantity, and a light emission timing of light generated by the light source device 4 based on the light irradiation amount calculated by the brightness detector 303 under the control of the process controller 309, and transmits a light source synchronization signal including the set conditions to the light source device 4.

The reading address setting unit 305 has a function of setting a reading target pixel on the light reception face of the sensor unit 244a and a reading sequence. That is, the reading address setting unit 305 has a function of setting an address of the pixel of the sensor unit 244a read by the AFE unit 244b. In addition, the reading address setting unit 305 outputs the address information of the set reading target pixel to the synchronization unit 302a.

The driving signal generating unit 306 generates a driving timing signal for driving the image pickup device 244, and transmits the timing signal to the timing generator 244c through a specified signal line included in the collective cable 248. The timing signal includes the address information of the reading target pixel.

The input unit 307 receives an input of various signals such as an operation instruction signal of instructing an operation of the endoscope system 1.

The recording unit 308 is realized using semiconductor memory such as flash memory and dynamic random access memory (DRAM). The recording unit 308 records various programs for operating the endoscope system 1, and data including various parameters necessary to operate the endoscope system 1. In addition, the recording unit 308 includes an identification information recording unit 308a that records identification information of the processing device 3. Here, the identification information includes unique information (ID) of the processing device 3, a model year, specification information of the process controller 309, a transmission method, and a transmission rate.

The process controller 309 is configured using a CPU or the like, and performs driving control of each constituent unit including the image pickup device 244 and the light source device 4, and input/output control of information about each constituent unit. The process controller 309 transmits the setting data for imaging control to the imaging controller 244i through a specified signal line included in the collective cable 248. The process controller 309 controls the image pickup device 244 based on the temperature information of the image pickup device 244, which is detected by the temperature detector 244d and is input from the endoscope 2.

The reference clock generating unit 310 generates a reference clock signal that is reference of the operation of each constituent unit of the endoscope system 1, and supplies the generated reference clock signal to each constituent unit of the endoscope system 1.

Next, a configuration of the light source device 4 will be described. The light source device 4 includes a light source 41, a light source driver 42, a rotation filter 43, a driving unit 44, a driving driver 45, and a light source controller 46.

The light source 41 is configured using a white LED, and generates white light under the control of the light source controller 46. The light source driver 42 supplies electric current to the light source 41 under the control of the light source controller 46, to cause the light source 41 to generate the white light. The light generated by the light source 41 is irradiated from the distal end of the distal end portion 24 through the rotation filter 43, a condenser lens (not illustrated), and the light guide 241. In addition, the light source 41 may be configured using a xenon lamp.

The rotation filter 43 is disposed on a light path of the white light emitted by the light source 41, and allows only light having a specified wavelength band of the white light emitted by the light source 41 to pass, by rotating. Specifically, the rotation filter 43 includes a red filter 431, a green filter 432, and a blue filter 433 which allow light having each wavelength band of red light (R), green light (G), and blue light (B) to pass. The rotation filter 43 allows light having wavelength bands of red, green, and blue (for example, red: 600 nm to 700 nm, green: 500 nm to 600 nm, and blue: 400 nm to 500 nm) to sequentially pass, by rotating. Accordingly, as for the white light emitted by the light source 41, it is possible to sequentially emit any light of the narrowing red light, green light, and blue light to the endoscope 2.

The driving unit 44 is configured using a stepping motor and a DC motor, and rotationally operates the rotation filter 43. The driving driver 45 supplies specified electric current to the driving unit 44 under the control of the light source controller 46.

The light source controller 46 controls the amount of electric current supplied to the light source 41 according to the light source synchronization signal transmitted from the light adjustment unit 304. In addition, the light source controller 46 drives the driving unit 44 through the driving driver 45 under the control of the process controller 309, to rotate the rotation filter 43.

The display device 5 has a function of receiving and displaying the in-vivo image generated by the processing device 3 from the processing device 3 through a video cable. The display device 5 is configured using liquid crystal or organic electro luminescence (EL).

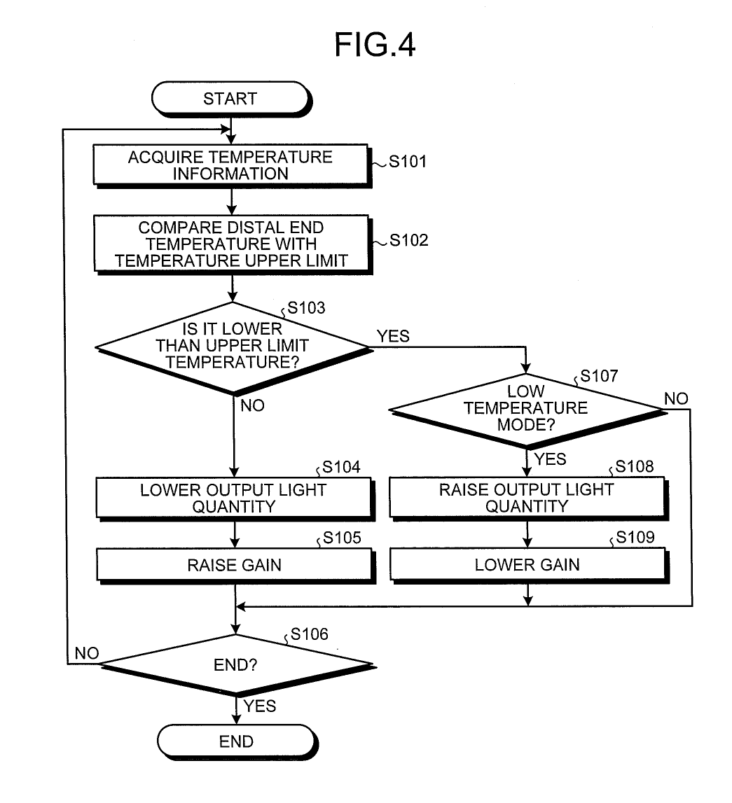

A process performed by the endoscope system 1 having the configuration described above will be described. FIG. 4 is a flowchart illustrating an outline of the process performed by the endoscope system 1.

As illustrated in FIG. 4, first, the process controller 309 acquires temperature information from the image pickup device 244 (Step S101). Specifically, the process controller 309 outputs the temperature information in the image pickup device 244 to the temperature detector 244d through the imaging controller 244i.

Subsequently, the process controller 309 compares a temperature of the acquired image pickup device 244 with a temperature upper limit drivable by the image pickup device 244 (Step S102). When the temperature of the image pickup device 244 is not lower than the upper limit temperature (No in Step S103), the process controller 309 performs control of lowering the output light quantity output from the light source device 4 (Step S104). Specifically, the process controller 309 performs control of lowering the output light quantity output from the light source device 4 by lowering the electric current supplied to the light source 41 by the light source driver 42 through the light source controller 46.

Subsequently, the process controller 309 performs control of raising a gain of the image signal input from the image pickup device 244 through the gain adjustment unit 302c (Step S105). Accordingly, even when the output light quantity output from the light source device 4 is lowered, it is possible to prevent the in-vivo image from being dark by raising the gain of the image signal generated by the image pickup device 244. In this case, the process controller 309 may reduce deterioration of the image quality of the in-vivo image by allowing the image processing unit 302 to perform a noise reducing process on the image signal.

Thereafter, the process controller 309 determines whether the examination of the subject by the endoscope 2 is completed (Step S106). When the process controller 309 determines that the examination of the subject by the endoscope 2 is completed (Yes in Step S106), the endoscope system 1 completes the process. On the contrary, when the process controller 309 determines that the examination of the subject by the endoscope 2 is not completed (No in Step S106), the endoscope system 1 proceeds back to Step S101.

In Step S103, the case where the temperature of the image pickup device 244 is lower than the upper limit temperature (Yes in Step S103) will be described. In this case, the process controller 309 determines whether the endoscope system 1 is set to a lower temperature mode (Step S107). Here, the lower temperature mode is an examination mode of restricting the output light quantity output from the light source device 4 such that the temperature of the distal end portion 24 does not exceed a specified temperature. When the process controller 309 determines that the endoscope system 1 is set to the lower temperature mode (Yes in Step S107), the endoscope system 1 proceeds to Step S108. On the contrary, the process controller 309 determines that the endoscope system 1 is not set to the lower temperature mode (No in Step S107), the endoscope system 1 proceeds to Step S106.

In Step S108, the process controller 309 performs control of raising the output light quantity output from the light source device 4. Specifically, the process controller 309 performs control of raising the output light quantity output from the light source device 4 by raising the electric current supplied to the light source 41 by the light source driver 42 through the light source controller 46.

Subsequently, the process controller 309 performs control of lowering a gain of the image signal input from the image pickup device 244 through the gain adjustment unit 302c (Step S109). Accordingly, even when the image pickup device 244 raises the gain of the generated image signal, the output light quantity output from the light source device 4 is raised, and thus it is possible to prevent the image quality (S/N) from being degraded while the brightness of the in-vivo image is maintained. Thereafter, the endoscope system 1 proceeds to Step S106.

According to the first embodiment of the invention described above, the process controller 309 controls the image pickup device 244 based on the temperature information of the image pickup device 244, which is detected by the temperature detector 244d. As a result, it is possible to perform correction of the image signal output from the image pickup device 244 with high precision.

In addition, according to the first embodiment of the invention, since the image pickup device 244 is provided with the temperature detector 244d, it is possible to further reduce the size of the image pickup device 244 itself. As a result, it is possible to thin a diameter of the distal end portion 24 of the endoscope 2.

Further, according to the first embodiment of the invention, since it is possible to directly detect the temperature of the image pickup device 244 itself of which the temperature rising is directly linked to image deterioration by providing the temperature detector 244d in the image pickup device 244, the temperature control can be performed with high precision.

In addition, in the first embodiment, the process controller 309 adjusts the output light quantity output from the light source device 4 based on the temperature information of the image pickup device 244, which is detected by the temperature detector 244d, but the temperature rising of the image pickup device 244 may be prevented, for example, by changing the number of pixels of the pixels P read from the light receiving unit 244j by the reading unit 244k.

Further, in the first embodiment, the process controller 309 may prevent the temperature rising of the image pickup device 244 by changing a frame rate of the image pickup device 244 based on the temperature information of the image pickup device 244, which is detected by the temperature detector 244d.

In addition, in the first embodiment, the process controller 309 reduces the data amount of the image signal output from the image pickup device 244 based on the temperature information of the image pickup device 244, which is detected by the temperature detector 244d, but the imaging controller 244i may reduce the data amount of the image signal. In this case, the imaging controller 244i performs reducing of the number of bits of one data item (one frame) or slowdown of reading of data. When the number of bits of one data item is reduced (when the bit rate is lowered), the imaging controller 244i reduces the number of bits of one data item output from any one of the sensor unit 244a, the noise reducing unit 244l, the AGC unit 244m, the A/D converter 244n, the superimposing unit 244e, and the P/S converter 244f. In addition, when the slowdown of the reading of data is performed (when the frame rate is lowered), the imaging controller 244i performs control of delaying the timing of the timing generator 244c to lower the frame rate of the data output from any one of the sensor unit 244a, the noise reducing unit 244l, the AGC unit 244m, the A/D converter 244n, the superimposing unit 244e, and the P/S converter 244f, thereby performing the slowdown of the reading of data.

In addition, in the first embodiment, the process controller 309 controls the image pickup device 244 based on the temperature information of the image pickup device 244, which is detected by the temperature detector 244d, but, for example, an FPGA (not illustrated) disposed in the connector portion 27 of the endoscope 2 may control the image pickup device 244 based on the temperature information of the image pickup device 244, which is detected by the temperature detector 244d. Of course, the image pickup device 244 may be controlled by an FPGA (not illustrated) provided in the operating unit 22.

In addition, in the first embodiment, the distal end portion 24 may be provided with a heater, and the process controller 309 may control driving of the heater based on the temperature information of the image pickup device 244, which is detected by the temperature detector 244d.

In addition, in the first embodiment, the imaging controller 244i may adjust the gain of the AGC unit 244m based on the temperature information of the image pickup device 244, which is detected by the temperature detector 244d.

In addition, in the first embodiment, the distal end portion 24 may be provided with a light emitting unit such as an LED, and the imaging controller 244i may control driving of the light emitting unit based on the temperature information of the image pickup device 244, which is detected by the temperature detector 244d.

In addition, in the first embodiment, the temperature information is superimposed on the image signal, but, for example, the temperature information may be superimposed on setting data (a control signal) to be output to the processing device 3.

In addition, in the first embodiment, the process controller 309 controls the output light quantity output from the light source device 4 based on the temperature information acquired from the temperature detector 244d, but, for example, a warning may be displayed on the display device 5 when the temperature acquired from the temperature detector 244d exceeds a threshold value.

### Second Embodiment

Next, the second embodiment of the invention will be described. An endoscope system according to a second embodiment is different only in a configuration of the image pickup device of the endoscope in the endoscope system according to the first embodiment described above. For this reason, in the following description, a configuration of an image pickup device of an endoscope in an endoscope system according to the second embodiment will be described. In addition, the same sign is given to the same configuration as that of the first embodiment described above.

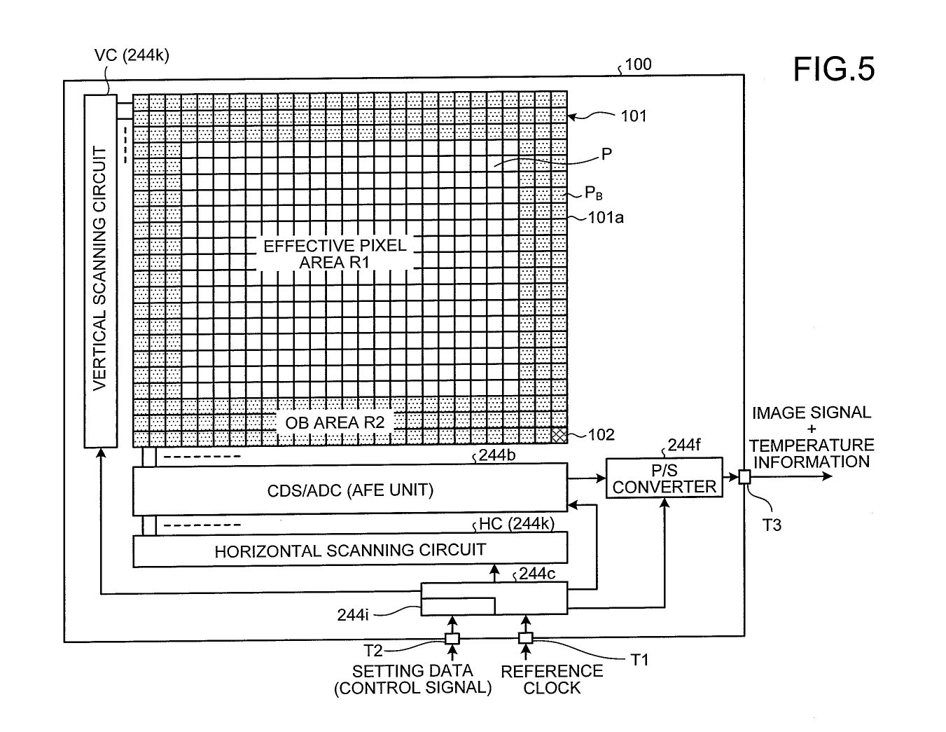

FIG. 5 is a schematic view illustrating a configuration of an image pickup device of an endoscope in endoscope system according to the second embodiment. An image pickup device 100 illustrated in FIG. 5 includes a sensor unit 101, an AFE unit 244b, a timing generator 244c, a P/S converter 244f, and an imaging controller 244i.

The sensor unit 101 includes a light receiving unit 101a in which a plurality of pixels P each having a photodiode that photoelectrically converts light from an optical system 243, outputs an electric signal as image information, and accumulates charges corresponding to light quantity and an amplifier that amplifies the charges accumulated in the photodiode are arranged in a two-dimensional matrix shape, and a vertical scanning circuit VC (a line selection circuit) and a horizontal scanning circuit HC (a column selection circuit) as a reading unit 244k that reads, as image information, the electric signal generated by a pixel P arbitrarily set as a reading target of the plurality of pixels P of the light receiving unit 101a. In addition, the light receiving unit 101a includes an effective pixel area R1 that performs outputting as the pixel information, and an OB area R2 that is constantly light-blocked by a film or the like to detect an output of a dark time. In addition, the sensor unit 101 includes a temperature detecting circuit 102 as a temperature detector that detects a temperature in the image pickup device 100.

The temperature detecting circuit 102 is provided in a light receiving unit 101a in the vicinity of the AFE unit 244b which generates a relatively high heat. The temperature detecting circuit 102 is realized by a light-blocked pixel P_{B} in the OB area R2. For example, the temperature detecting circuit 102 monitors a forward voltage of the pixel P_{B}, and quantizes it to detect the temperature of the image pickup device 100.

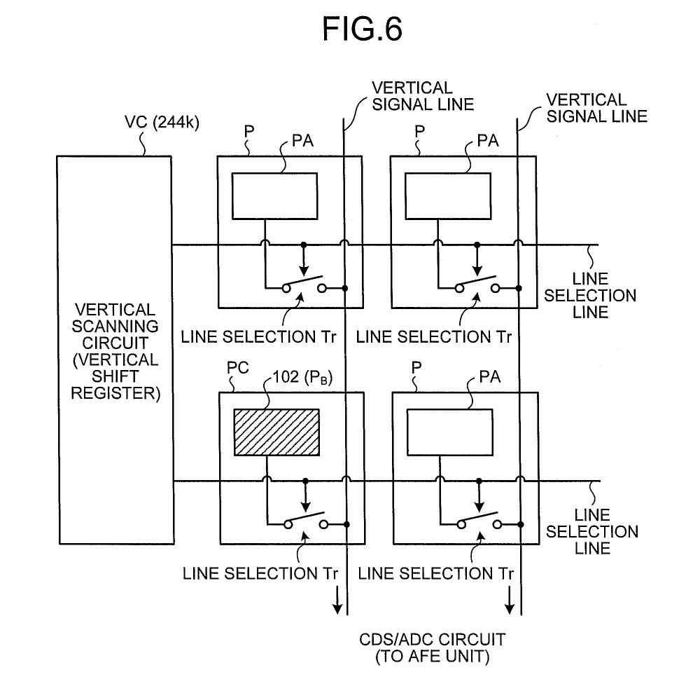

Here, the temperature detecting circuit 102 will be described. FIG. 6 is an enlarged view schematically enlarging some main parts of a normal pixel P including the temperature detecting circuit 102.

The normal pixel P illustrated in FIG. 6 includes an in-pixel circuit PA and a line selection Tr that is controlled to be turned on when a horizontal line including the unit pixel is selected as a reading target line. The in-pixel circuit PA includes, a photodiode (PD), a capacitor (FD) that converts a signal charge transmitted from the photodiode into a voltage level, a transmission transistor (T-TR) that transmits the signal charge accumulated in the photodiode during the ON period to the capacitor, a reset transistor (RS-TR) that discharges and resets the signal charge accumulated in the capacitor, and an output transistor (SF-TR) that amplifies the signal charge transmitted to the capacitor when the line selection Tr is turned on, as change of a voltage level, and outputs it to a specified signal line. In the normal pixel P, when a reset pulse φRSP becomes a high level (rises), the reset transistor is controlled to be turned on, and the capacitor is reset. Thereafter, in the normal pixel P, the signal charges corresponding to incident light quantity are sequentially accumulated in the photodiode. Subsequently, in the normal pixel P, when the transmission transistor is controlled to be turned on (when a charge transmission pulse φTR rises), the transmission of the signal charges from the photodiode to the capacitor is started. Accordingly, the signal charge of the normal pixel P is transmitted to the AFE unit 244b as voltage.

The temperature detecting circuit 102 configured in a temperature detecting pixel PC monitors and measures a forward voltage of a PN junction which changes with temperature so as to detect the temperature in the image pickup device 100. The PN junction portion may be configured by modifying the structure of the photodiode in the pixel, and may be configured by modifying a diffusion layer other than the photodiode. The temperature information signal from the temperature detecting circuit 102 in the temperature detecting pixel PC is read on the vertical signal line simultaneously with the image signal from the in-pixel circuit PA in another normal pixel P by controlling the line selection Tr connected to the line selection line to be turned on, and is output to the AFE unit 244b.

According to the second embodiment of the invention described above, since the temperature detecting circuit 102 in the temperature detecting pixel PC is configured by the pixel P_{B} of the OB area R2 of the light receiving unit 101a of the sensor unit 101 in the image pickup device 100, it is possible to output the temperature of the image pickup device 100 to the processing device 3 even when the temperature detector and the superimposing unit (the superimposing circuit) that superimposes the temperature information detected by the temperature detector described above are not separately provided. Accordingly, it is possible to further reduce a chip area of the image pickup device 100.

In addition, according to the second embodiment, since the quantization is performed using the same ADC as the image signal (the video signal), it is possible to obtain the temperature information with higher precision.

In the second embodiment, the temperature detecting circuit 102 is provided at one portion of the OB area R2, but a plurality of temperature detecting circuits may be provided. In this case, the plurality of temperature detecting circuits 102 may be provided in the OB area R2 near the AFE unit 244b. In addition, the temperature detecting circuits 102 may be provided at four corners of the OB area R2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medical system comprising:
an image pickup device configured to output, as image information, an electric signal after photoelectric conversion from a plurality of pixels; and
a processing device that is connected to the image pickup device to allow bi-directional communication,
the image pickup device comprising:
a signal processing unit configured to perform a process of converting the electric signal into the image information, and to generate heat accompanying the process,
a temperature detector that is provided in vicinity to the signal processing unit, and is configured to detect temperature of the signal processing unit, and
an output unit configured to output temperature information on the temperature detected by the temperature detector, together with the image information, and
the processing device comprising a controller configured to control the image pickup device based on the temperature information input from the output unit.

2. The medical system according to claim 1, wherein the signal processing unit is an A/D converter configured to convert the electric signal into a digital signal, and
wherein the temperature detector is provided in vicinity to the A/D converter.

3. The medical system according to claim 1, wherein the temperature detector is configured to detect the temperature of the signal processing unit based on an output of a light-blocked pixel of the plurality of pixels.

4. The medical system according to claim 1, wherein the controller is configured to change the number of pixels of a reading target in the image pickup device based on the temperature information.

5. The medical system according to claim 1, further comprising:
an illumination unit configured to emit light; and
an illumination controller configured to control driving of the illumination unit based on the temperature information detected by the temperature detector.
